(19) United States
(12) Patent Application Publication
(10) Pub. No.: US 2010/0238592 A1
(43) Pub. Date: Sep. 23, 2010

(54) HEAD SLIDER AND MAGNETIC STORAGE DEVICE

(75) Inventor: Akiyo MIZUTANI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/719,754

(22) Filed: Mar. 8, 2010

(30) Foreign Application Priority Data
Mar. 18, 2009 (JP) 2009-066911

(51) Int. Cl. G11B 5/60

(52) U.S. Cl. 360/235.4; G9B/5.229

(57) ABSTRACT

According to one embodiment, a head slider includes a magnetic head, a medium facing surface, a flow-in end surface, a flow-out end surface, side surfaces, and an absorbing structure. The magnetic head reads and writes information with respect to a magnetic recording medium. The medium facing surface faces the magnetic recording medium. From the flow-in end surface, an airflow generated by rotation of the magnetic recording medium flows in. To the flow-out end surface, the airflow is guided from the flow-in end surface through the medium facing surface. The side surfaces are located on both sides of the medium facing surface. The absorbing structure is provided to at least one of the flow-out end surface and the side surfaces. The absorbing structure absorbs flowing substances guided with the airflow.

### CROSS-REFERENCE TO RELATED APPLICATIONS

This application is based upon and claims the benefit of priority from Japanese Patent Application No. 2009-066911, filed Mar. 18, 2009, the entire contents of which are incorporated herein by reference.

### BACKGROUND

1. Field

One embodiment of the invention relates to a head slider and a magnetic storage device.

2. Description of the Related Art

In recent years, a distance (a flying height of a head slider) between the flying surface of a magnetic head (head slider) provided to a magnetic storage device and a magnetic storage medium is required to be small to increase the recording density. Specifically, the minimum flying height of the head slider mounted with such a magnetic head is already smaller than or equal to a few nm.

However, if the flying height of the head slider is so small, lubricating agent forming a lubricating layer on the surface of the magnetic recording medium attaches to the head slider.

The situation related to the flying height of the head slider will be described below referring to FIG. 7. FIG. 7 is a view of a conventional head slider. As illustrated in FIG. 7, the bottom surface (a flying surface 9) of a head slider 7 supported by a suspension 8 floats from a magnetic recording medium 2 by a small amount due to airflow.

The surface of the magnetic recording medium 2 is coated with a lubricating agent for reducing friction between the magnetic recording medium 2 and the head slider 7. Thus, the lubricating agent, which has vaporized while the magnetic recording medium 2 is rotating, attaches to the bottom surface (the flying surface 9) of the head slider 7, and the attached lubricating agent accumulates to thereby become liquid droplets and drops on the magnetic recording medium 2.

In other words, as illustrated in FIG. 7, airflow is generated between the head slider 7 and the magnetic recording medium 2 due to the rotation of the magnetic recording medium 2. Since the airflow flows from the upstream side to the downstream side of the head slider, the lubricating agent moves to and deposits on an end surface (hereinafter, “flow-out end surface 9a”) perpendicularly extending from the flying surface 9 of the head slider 7 on the downstream side. If the lubricating agent is deposited on the flow-out end surface 9a of the head slider 7, the lubricating agent forms a clump of a certain size and drops on the magnetic recording medium 2.

If the clump of lubricating agent deposited on the flow-out end surface 9a drops on the magnetic recording medium 2, the surface of the magnetic recording medium 2 becomes contaminated, and the clump of lubricating agent inhibits the stable flying of the head slider 7 or damages the magnetic head arranged in the head slider 7.

To avoid such situation, for example, Japanese Patent Application Publication (KOKAI) No. 10-269542 discloses a conventional technology related to a head slider for holding lubricating agent by applying a cured resin to the medium facing surface of the head slider facing the magnetic medium to make the medium facing surface porous.

According to the conventional technology, a cured resin film is formed on the medium facing surface (flying surface) of the head slider.

If the cured resin film is formed on the flying surface of the head slider, the flying property of the head slider is adversely affected. Furthermore, if the lubricating agent is transferred from the medium facing surface of the head slider to a portion close to the flow-out end surface through the medium facing surface, it is difficult to hold the transferred clump of lubricating agent and the like on the head slider. Accordingly, the head slider may be contaminated, the magnetic head may be damaged, and the stability of flying of the head slider may not be maintained.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary appearance view of the interior of a magnetic storage device according to a first embodiment of the invention;

FIG. 2 is an exemplary perspective view of a head slider in the first embodiment;

FIG. 3 is an exemplary perspective view of a head slider according to a second embodiment of the invention;

FIG. 4 is an exemplary perspective view of a head slider according to a third embodiment of the invention;

FIG. 5 is an exemplary perspective view of a head slider according to a fourth embodiment of the invention;

FIG. 6 is an exemplary functional block diagram of a magnetic storage device according to an embodiment of the invention; and

FIG. 7 is an exemplary view of a conventional head slider.

### DETAILED DESCRIPTION

Various embodiments according to the invention will be described hereinafter with reference to the accompanying drawings. In general, according to one embodiment of the invention, a head slider comprises a magnetic head, a medium facing surface, a flow-in end surface, a flow-out end surface, side surfaces, and an absorbing structure. The magnetic head is configured to read and write information with respect to a magnetic recording medium. The medium facing surface is configured to face the magnetic recording medium. From the flow-in end surface, an airflow generated by rotation of the magnetic recording medium flows in. To the flow-out end surface, the airflow is guided from the flow-in end surface through the medium facing surface. The side surfaces are located on both sides of the medium facing surface. The absorbing structure is provided to at least one of the flow-out end surface and the side surfaces. The absorbing structure is configured to absorb flowing substances guided with the airflow.

According to another embodiment of the invention, a magnetic storage device comprises a magnetic recording medium, a driver, and a head slider. The driver is configured to rotate the magnetic recording medium. The head slider comprises a magnetic head, a medium facing surface, a flow-in end surface, a flow-out end surface, side surfaces, and an absorbing structure. The magnetic head is configured to read and write information with respect to a magnetic recording medium. The medium facing surface is configured to face the magnetic recording medium. From the flow-in end surface, an airflow generated by rotation of the magnetic recording medium flows in. To the flow-out end surface, the airflow is guided from the flow-in end surface through the medium facing surface. The side surfaces are located on both sides of the medium facing surface. The absorbing structure is provided to at least one of the flow-out end surface and the side surfaces. The absorbing structure is configured to absorb flowing substances guided with the airflow.

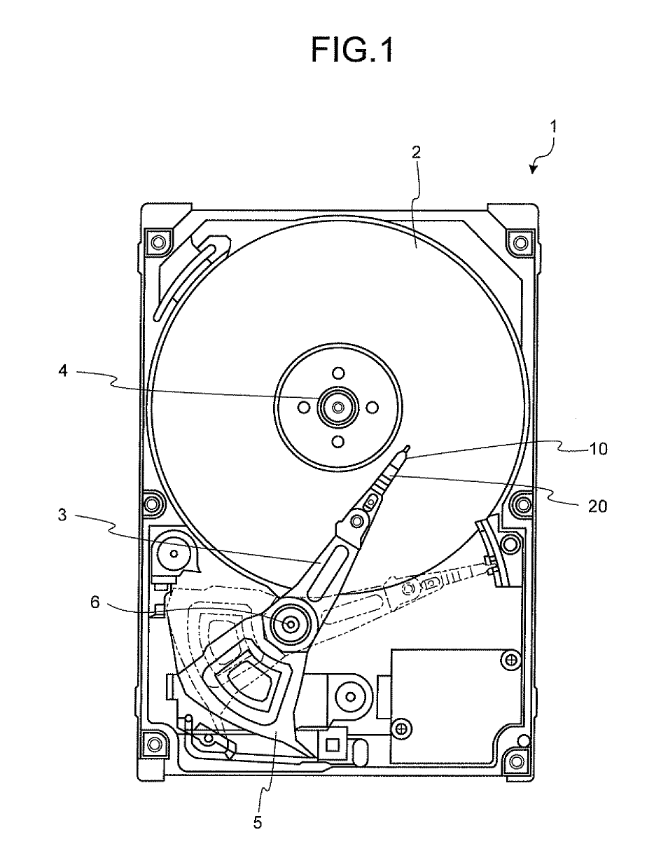

A magnetic storage device 1 according to a first embodiment of the invention will be described. FIG. 1 is a view of the interior of the magnetic storage device 1 according to the first embodiment. As illustrated in FIG. 1, the magnetic storage device 1 comprises a magnetic recording medium 2, a head slider 20 supported by a suspension 3, and a spindle motor (SPM) 4. The magnetic storage device 1 also comprises a voice coil motor (VCM) 5, which is a drive mechanism of the suspension 3 (the head slider 20).

The magnetic recording medium 2 is a magnetic storage medium for recording various types of magnetic information at high recording density, and is rotationally driven in a predetermined direction (counterclockwise direction in FIG. 1) by the SPM 4.

A magnetic head 10 for reading and writing magnetic information inform/to the magnetic recording medium 2 is provided at the end of the head slider 20 supported by the suspension 3.

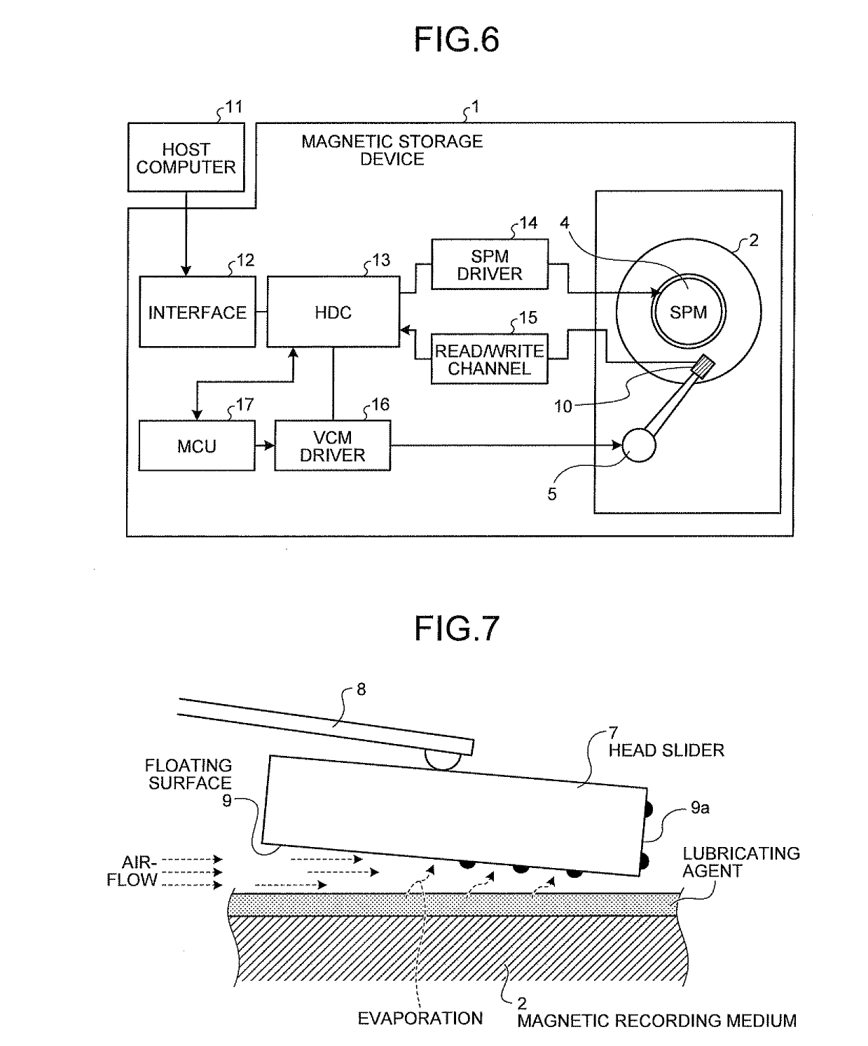

The VCM 5 controls the position and the speed of the magnetic head 10. Specifically, the VCM 5 increases the speed of the magnetic head 10 or stops the operation of the magnetic head 10 based on current supplied from a VCM driver 16 (FIG. 6).

In the magnetic storage device 1 described above, the magnetic head 10 provided at the end of the head slider 20 seeks in a direction across tracks of the magnetic recording medium 2 and changes tracks to be read or written when the suspension 3 rotates on a circular arc having a shaft portion 6 as the center by the drive of the VCM 5. Tracks to be read or written can be changed by moving the magnetic head 10 provided to the head slider 20 in the width direction of the tracks of the magnetic recording medium 2.

The magnetic head 10 moves to a track to be read or written and performs a read operation and a write operation (reading/writing of data) while slightly floating from the surface of the magnetic recording medium 2 by the lifting force generated by the rotation of the magnetic recording medium 2.

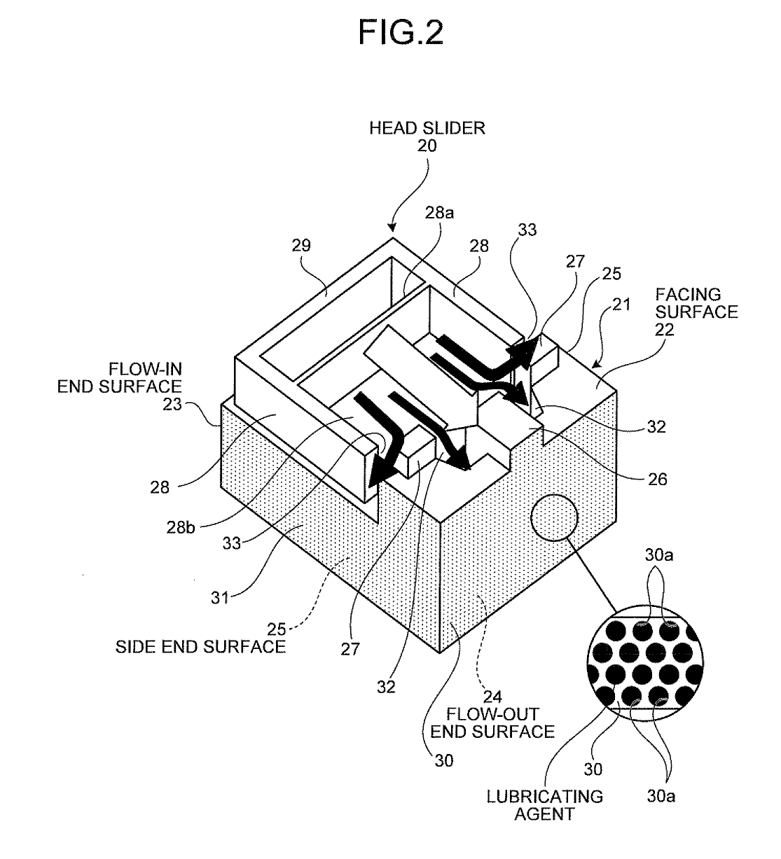

The details on the shape of the head slider of the first embodiment will be described referring to FIG. 2. FIG. 2 is a perspective view of the head slider of the first embodiment. The white arrow in FIG. 2 indicates the direction of airflow that flows on the head slider. The black arrows indicate the direction of flow of the lubricating agent attached to the head slider through the magnetic recording medium.

As illustrated in FIG. 2, the head slider 20 comprises a slider main body 21 formed as a whole in a substantially square shape. The slider main body 21 is formed with an facing surface 22 facing the magnetic recording medium 2 (FIG. 1), a flow-in end surface 23 from which the airflow flows in, and a flow-out end surface 24 from which the airflow flows out.

The facing surface 22 facing the magnetic recording medium 2 illustrated in FIG. 2 serves as the flying surface. A pair of side end surfaces 25 is formed on the sides (at left and right positions) of the facing surface 22 of the head slider 20.

As illustrated in FIG. 2, the facing surface 22 that serves as the flying surface of the head slider 20 is formed with a center pad portion 26 and a pair of side pad portions 27 raised from the facing surface 22, and a flow-in side projection 29 entirely formed in a U shape with a pair of side surfaces 28 and a partition plate 28a. The center pad portion 26 is a raised portion arranged at the middle in the width direction on the flow-out end surface 24 side, and the magnetic head 10 (FIG. 1) is fixed to the end of the center pad portion 26.

The side pad portions 27 are raised portions arranged to sandwich a part of the center pad portion 26, and allows the lubricating agent to flow out from gaps 32 formed at two areas between the side pad portions 27 and the center pad portion 26.

The flow-in side projection 29 is a raised portion arranged on the flow-in end surface 23 side of the head slider 20, and guides the airflow flowing in from the flow-in end surface 23 towards the flow-out end surface 24 through the facing surface 22.

The region of the facing surface 22 surrounded by the side surfaces 28 and the partition plate 28a forming the flow-in side projection 29 is a negative pressure region 28b. The negative pressure region 28b is formed as a region that receives airflow generated when the head slider 20 moves above the magnetic recording medium 2 at high speed, and generates a pressure in the direction of separating the head slider 20 from the magnetic recording medium 2, i.e., in the direction of increasing the flying height.

By forming three raised portions comprising the center pad portion 26 and the side pad portions 27, and the flow-in side projection 29 with the U-shaped side surface 28 on the flying surface (the facing surface 22) of the head slider 20 as described above, the flying surface is formed not to have a region where the shear stress acted due to the airflow concentrates at one point of the facing surface 22 (flying surface). Specifically, the facing surface 22 is formed in a shape in which the lubricating agent is less likely to accumulate on the facing surface 22.

Furthermore, the facing surface 22 of the head slider 20 is formed in such a shape that the height (inclination) of the facing surface 22 becomes lower towards the flow-out end surface 24 from the flow-in end surface 23 side. Specifically, the shape of the facing surface 22 is formed to be an inclined portion such that the flow of the lubricating agent, which is an unwanted flowing substance, is accelerated from the facing surface 22 of the head slider 20 towards the flow-out end surface 24.

The lubricating agent attached on the facing surface 22 of the head slider 20 thus can be efficiently guided towards the flow-out end surface 24 on the flowing substance discharging side.

In the head slider 20 of the first embodiment, a porous film portion 30 capable of absorbing and holding the lubricating agent attached to the facing surface 22 through the magnetic recording medium 2 is provided on the flow-out end surface 24, from which the airflow flows out and which forms the facing surface 22 of the head slider 20.

In other words, as illustrated in FIG. 1, a porous ceramic film is formed on the surface of the flow-out end surface 24 of the head slider 20 to cover the entire surface of the flow-out end surface 24. The porous ceramic film formed on the flow-out end surface 24 may be made of porous silica, porous alumina, polyethylene particles, or the like.

When manufacturing the head slider 20 illustrated in FIG. 2, the facing surface 22 (flying surface) of the head slider 20 may be processed through milling, etching, or the like. Specifically, a series of manufacturing works including resist coating, resist processing by photolithography, processing of an object by milling or etching, resist removal, and the like is performed every time an element to be formed on the facing surface 22 is formed.

The porous film portion 30 such as porous silica is formed on the flow-out end surface 24 of the head slider 20 through coating or vapor deposition method at substantially the same time as the manufacture of a substrate used for manufacturing the head slider 20, or after the substrate is manufactured.

In the first embodiment, the porous ceramic film is formed as a porous film portion 31 on the side end surfaces 25 at the sides of the facing surface 22 of the head slider 20 to cover the entire surfaces of the side end surfaces 25.

As illustrated in FIG. 1, in the head slider 20 of the first embodiment, the lubricating agent guided straightly from the facing surface 22 out of the lubricating agent attached to the facing surface 22 passes from the facing surface 22 through the gaps 32 at two areas between the center pad portion 26 and the side pad portions 27, and absorbed and held by the porous film portion 30 provided on the flow-out end surface 24.

Specifically, the lubricating agent attached to the porous film portion 30 infiltrates to a plurality of holes 30a forming the porous film portion 30 to be held inside the holes 30a.

The lubricating agent guided towards the sides of the facing surface 22 passes from the facing surface 22 through gaps 33 at two areas between the side pad portions 27 and the side surfaces 28, and absorbed and held by the porous film portion 31 provided on the side end surfaces 25.

In the head slider 20 of the first embodiment, the porous film portions 30, 31 are formed on the entire surfaces of the flow-out end surface 24 and the side end surfaces 25 of the head slider 20, from which the airflow flows out. Thus, the lubricating agent attached to the facing surface 22 of the head slider 20 through the magnetic recording medium 2 can be efficiently absorbed and held by the porous film portions 30, 31.

Since the lubricating agent attached to the facing surface 22 of the head slider 20 can be thus smoothly absorbed and held, the accumulation of the lubricating agent can be eliminated. Moreover, the dropping of the lubricating agent onto the magnetic recording medium 2 can be reliably prevented by holding the absorbed lubricating agent.

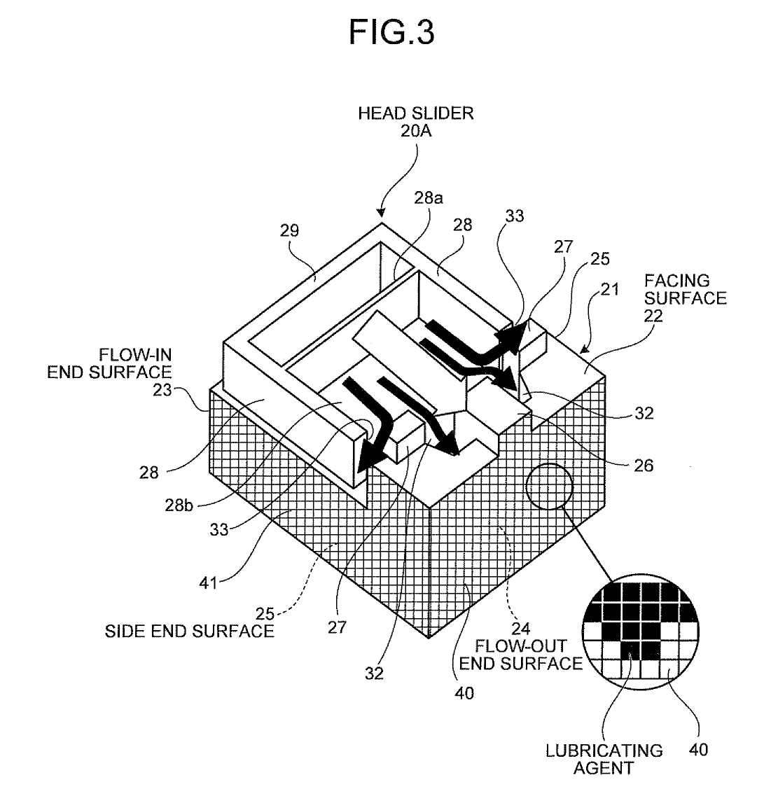

A head slider 20A according to a second embodiment of the invention will now be described. FIG. 3 is a perspective view of the head slider 20A of the second embodiment. Constituent elements corresponding in function and structure to those of the head slider 20 of the first embodiment will be designated by like reference numerals, and their description will not be repeated.

As illustrated in FIG. 3, the head slider 20A of the second embodiment comprises the slider main body 21 formed as a whole in a substantially square shape. The slider main body 21 of the head slider 20A is formed with the facing surface 22 facing to the magnetic recording medium 2, the flow-in end surface 23 from which the airflow flows in, the flow-out end surface 24 and the side end surfaces 25 formed on the sides (at left and right positions) of the facing surface 22 from which the airflow flows out.

In the head slider 20A of the second embodiment, a long fiber member 40 is attached and fixed to the flow-out end surface 24, from which the airflow flows out, to cover the entire surface of the flow-out end surface 24. A nonwoven fabric coated with lipophilic medical fluid or the like may be used for the long fiber member 40.

In other words, by using the nonwoven fabric coated with lipophilic medical fluid for the long fiber member 40, the infiltration of the lubricating agent can be promoted and the lubricating agent can be held by the long fiber member 40 easily and reliably.

In the second embodiment, a long fiber member 41 is also attached and fixed to the side end surfaces 25 formed on the sides of the facing surface 22 of the head slider 20, similarly to the first embodiment, to cover the entire surfaces of the side end surfaces 25.

As illustrated in FIG. 3, in the head slider 20A of the second embodiment, the lubricating agent guided straightly from the facing surface 22 out of the lubricating agent attached to the facing surface 22 passes from the facing surface 22 through the gaps 32 at two areas between the center pad portion 26 and the side pad portions 27, and absorbed and held by the long fiber member 40 provided at the flow-out end surface 24.

The lubricating agent guided towards the sides of the facing surface 22 passes from the facing surface 22 through the gaps 33 at two areas between the side pad portions 27 and the side surfaces 28, and absorbed and held by the long fiber member 41 provided on the side end surfaces 25.

In the head slider 20A of the second embodiment, the long fiber members 40, 41 are attached and fixed to the entire surfaces of the flow-out end surface 24 and the side end surfaces 25 of the head slider 20A, from which the airflow flows out.

With this configuration, the lubricating agent attached to the facing surface 22 of the head slider 20 through the magnetic recording medium 2 can be efficiently absorbed and held by the long fiber members 40, 41. Thus, the accumulation of the lubricating agent can be eliminated and the dropping of the lubricating agent onto the magnetic recording medium 2 can be reliably prevented.

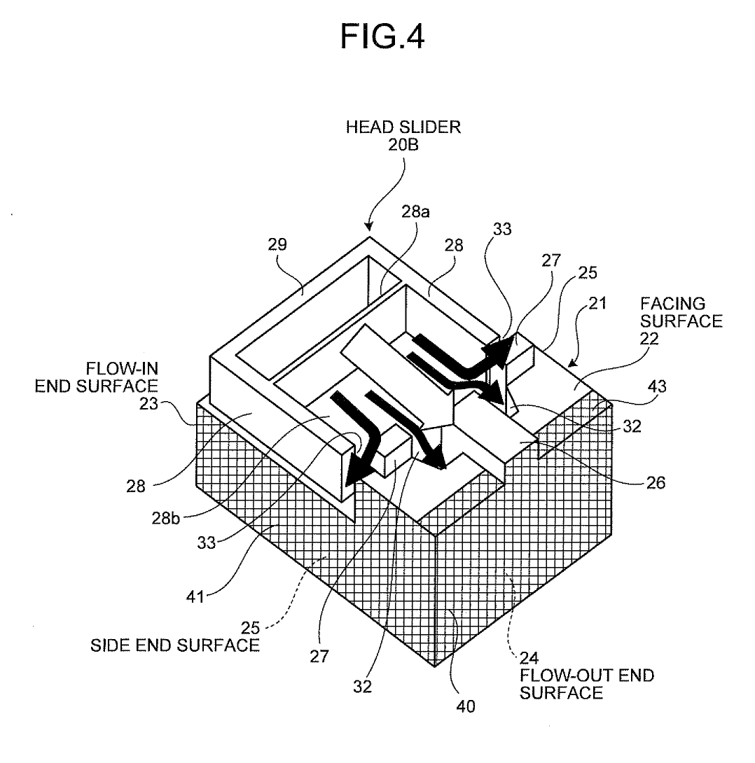

A head slider 20B according to a third embodiment of the invention will now be described. FIG. 4 is a perspective view of a flying surface of the head slider 20B of the third embodiment. Constituent elements corresponding in function and structure to those of the head slider 20A of the second embodiment will be designated by like reference numerals, and their description will not be repeated.

As illustrated in FIG. 4, according to the third embodiment, the long fiber member 40 is attached and fixed to the flow-out end surface 24 and the side end surfaces 25 forming the head slider 20B to cover the entire surfaces of the flow-out end surface 24 and the side end surfaces 25. Further, the long fiber member 40 attached to the flow-out end surface 24 is extended, and the extended portion (long fiber member 43) is arranged on a part of the facing surface 22.

Specifically, a long fiber member 43 is arranged to sandwich the center pad portion 26 at the back end region (a part in the width direction) of the facing surface 22 forming the head slider 20B for efficiently infiltrating of the lubricating agent attached to the facing surface 22.

In this manner, by arranging the long fiber member 43 at the back end region of the facing surface 22, the lubricating agent before reaching the long fiber member 43 arranged on the flow-out end surface 24 can be efficiently absorbed.

In the head slider 20B of the third embodiment, the long fiber members 40, 41 are attached and fixed to the entire surfaces of the flow-out end surface 24 and the side end surfaces 25 of the head slider 20B, from which the airflow flows out, and the long fiber member 40 attached to the flow-out end surface 24 is extended and the extended portion is arranged on apart of the facing surface 22 as the long fiber member 43. Therefore, the lubricating agent that is attached to the facing surface 22 but is not guided to the flow-out end surface 24 by the long fiber member 43 can be efficiently guided to reach the side of the long fiber member 40 arranged on the flow-out end surface 24 and can be absorbed by the long fiber member 40.

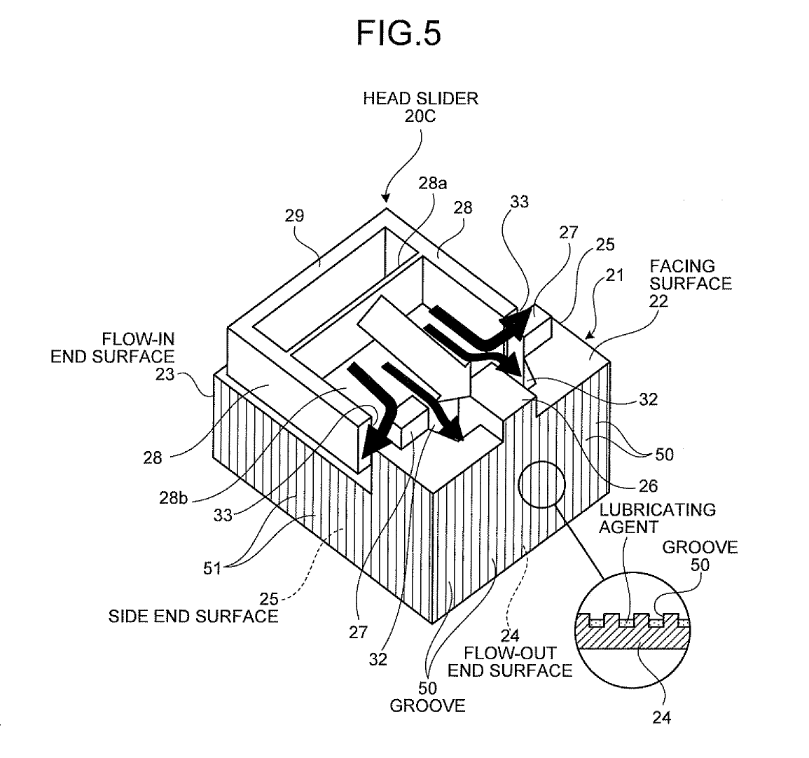

A head slider 20C according to a fourth embodiment of the invention will now be described. FIG. 5 is a perspective view of a flying surface of the head slider 20C of the fourth embodiment. Constituent elements corresponding in function and structure to those of the head slider 20 (20A, 20B) of the first to third embodiments will be designated by like reference numerals, and their description will not be repeated.

As illustrated in FIG. 5, the head slider 20C of the fourth embodiment comprises the slider main body 21 formed as a whole in a substantially square shape. The slider main body 21 of the head slider 20C is formed with the facing surface 22 facing to the magnetic recording medium 2, the flow-in end surface 23 from which the airflow flows in, the flow-out end surface 24 and the side end surfaces 25 formed on the sides (at left and right positions) of the facing surface 22 from which the airflow flows out.

As illustrated in FIG. 5, in the head slider 20C of the fourth embodiment, a plurality of narrow (about 10 μm) grooves 50, 51 is formed on the entire surfaces of the flow-out end surface 24 and the side end surfaces 25 (on their surfaces) to extend away from the back end of the facing surface 22. By thus forming the grooves 50, 51 on the flow-out end surface 24 and the side end surfaces 25 of the head slider 20, the lubricating agent attached to the facing surface 22 of the head slider 20 and guided by the airflow on the facing surface 22 can be absorbed and held by the grooves 50, 51 formed on the flow-out end surface 24 and the side end surfaces 25.

Specifically, the lubricating agent that has infiltrated to the grooves 50, 51 is sucked up by the capillary phenomenon of the grooves 50, 51, and held inside the grooves 50, 51.

In the head slider 20C of the fourth embodiment, the grooves 50, 51 are formed on the entire surfaces of the flow-out end surface 24 and the side end surfaces 25 of the head slider 20C, from which the airflow flows out, to extend away from the back end of the facing surface 22, and thus the lubricating agent attached to the facing surface 22 of the head slider 20 can be absorbed and held by the grooves 50, 51. Therefore, the accumulation of the lubricating agent can be eliminated, and the lubricating agent can be reliably prevented from dropping onto the magnetic recording medium 2.

The internal configuration of the magnetic storage device comprising the head slider of any of the first to the fourth embodiments will now be described referring to FIG. 6. FIG. 6 is a function block diagram of the magnetic storage device.

As illustrated in FIG. 6, the magnetic storage device 1 comprises an interface 12 connected to a host computer 11, a hard disk controller (HDC) 13, an SPM driver 14, a read/write channel 15, the VCM driver 16, and a micro control unit (MCU) 17.

The interface 12 controls communication related to various types of information with the host computer 11. Specifically, the interface 12 receives various control signals such as a read signal and a write request signal of data transmitted from the host computer 11 to the magnetic recording medium 2, and transmits the received signals to the HDC 13.

The HDC 13 receives various instructions from the host computer 11 through the interface 12 and sends the instructions to respective functional elements. Upon receipt of a control instruction from the SPM driver 14, the HDC 13 sends the control instruction to the SPM 4.

When the HDC 13 receives a control instruction for the magnetic head 10, the HDC 13 sends the control instruction to the VCM driver 16 or the MCU 17. Upon receipt of a data read/write instruction, the HDC 13 sends the same to the read/write channel 15 to write data, or transmits the data to the host computer 11.

The SPM driver 14 controls the drive of the SPM 4 for rotating the magnetic recording medium 2. Specifically, the SPM driver 14 supplies current for activating the SPM 4 or supplies current for stopping the SPM 4 in response to a request instruction from the MCU 17.

The read/write channel 15 comprises a modulation circuit for writing data to the magnetic recording medium 2, a demodulation circuit for reading data from the magnetic recording medium 2, and the like, to control the read and write of data with respect to the magnetic recording medium 2.

The VCM driver 16 sends various control requests for controlling the speed or the position of the magnetic head 10 to the VCM 5 to drive the VCM 5. Whereby, the speed and the position of the magnetic head 10 are controlled.

The MCU 17 is a controller for controlling the magnetic storage device 1 and comprises an internal memory for storing programs defining the various processing procedures and necessary data.

In the first embodiment, although the porous ceramic film is formed to cover the entire surfaces of the flow-out end surface 24 and the side end surfaces 25 of the head slider 20, the ceramic film may be formed on a part of the flow-out end surface 24 and the side end surfaces 25 rather than their entire surfaces.

Similarly, in the second embodiment, although the long fiber member is attached and fixed to cover the entire surfaces of the flow-out end surface 24 and the side end surfaces 25 of the head slider 20, the long fiber member may be attached and fixed to a part of the flow-out end surface 24 and the side end surfaces 25 rather than their entire surfaces.

Similarly, in the fourth embodiment, although the grooves 50, 51 are formed on the entire regions of the flow-out end surface 24 and the side end surfaces 25 of the head slider 20, the grooves 50, 51 may be formed on a part of the flow-out end surface 24 and the side end surfaces 25 rather than their entire surfaces.

Furthermore, in the first to the fourth embodiments, the long fiber member and the grooves as an absorbing structure for holding the lubricating agent are respectively arranged on the side end surfaces 25 as well as the flow-out end surface 24 of the head slider, the absorbing structure such as the long fiber member and the grooves may be arranged only on the flow-out end surface 24 without requiring the absorbing structure on the side end surfaces 25 of the head slider.

As described above, according to the embodiments of the invention, the head slider arranged in the magnetic storage device is provided with an absorbing structure for absorbing and holding the lubricating agent attached to the medium facing surface on the flow-out end surface of the head slider. Thus, the lubricating agent attached to the head slider can be prevented from forming a clump and dropping onto the magnetic recording medium even if flowing on the head slider. Whereby, contamination with respect to the magnetic recording medium and adverse affect with respect to the flying of the head slider are prevented, and the stability can be enhanced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head slider comprising:
a magnetic head configured to read and write information with respect to a magnetic recording medium;
a medium facing surface configured to face the magnetic recording medium;
a flow-in surface configured to pass an airflow generated by rotation of the magnetic recording medium;
a flow-out surface configured to pass the airflow from the flow-in surface through the medium facing surface;
side surfaces on both sides of the medium facing surface; and
an absorbing structure provided on at least the flow-out surface or the side surfaces, the absorbing structure configured to absorb flowing substances guided with the airflow.

2. The head slider of claim 1, wherein the absorbing structure is a porous film on at least one of the flow-out surface and the side surfaces.

3. The head slider of claim 1, wherein the absorbing structure is a long fiber material on at least one of the flow-out surface and the side surfaces.

4. The head slider of claim 3, wherein the long fiber material is configured to extend up to one part of the medium facing surface.

5. The head slider of claim 1, wherein the absorbing structure is a plurality of grooves on at least one of the flow-out surface and the side surfaces to extend in a direction away from an end on a medium facing surface side.

6. The head slider of claim 1, further comprising a groove configured to guide the flowing substances attached to the medium facing surface in a direction of the airflow flowing out on the medium facing surface, wherein
an inclination of the groove becomes greater towards the flow-out surface than towards the flow-in surface.

7. A magnetic storage device comprising:
a magnetic recording medium;
a driver configured to rotate the magnetic recording medium; and
a head slider comprising
a magnetic head configured to read and write information with respect to the magnetic recording medium,
a medium facing surface configured to face the magnetic recording medium,
a flow-in surface configured to pass an airflow generated by rotation of the magnetic recording medium,
a flow-out surface configured to pass the airflow from the flow-in surface through the medium facing surface,
side surfaces on both sides of the medium facing surface, and
an absorbing structure provided on at least the flow-out surface or the side surfaces, the absorbing structure configured to absorb flowing substances guided with the airflow.

8. The magnetic storage device of claim 7, wherein the absorbing structure is a porous film on at least one of the flow-out surface and the side surfaces.

9. The magnetic storage device of claim 7, wherein the absorbing structure is a long fiber material provided to at least one of the flow-out surface and the side surfaces.

10. The magnetic storage device of claim 7, wherein the absorbing structure is a plurality of grooves on at least one of the flow-out surface and the side surfaces to extend in a direction away from an end on a medium facing surface side.

11. The magnetic storage device of claim 7, wherein the absorbing structure is provided on the flow-out surface and the side surfaces.
